(19) United States
(12) Patent Application Publication
(10) Pub. No.: US 2020/0202229 A1
(43) Pub. Date: Jun. 25, 2020

(54) INFORMATION PROCESSING DEVICE, INFORMATION PROCESSING SYSTEM, PROGRAM, AND INFORMATION PROCESSING METHOD

(71) Applicant: TOYOTA JIDOSHA KABUSHIKI KAISHA, Toyota-shi (JP)

(72) Inventors: Hirofumi Momose, Numadu-shi (JP); Hideto Fujishima, Miyoshi-shi (JP); Naoki Kurokawa, Tokyo (JP); Yuki Tao, Nagoya-shi (JP); Yasuhisa Obata, Nagoya-shi (JP); Hiroki Ilda, Toyota-shi (JP)

(73) Assignee: TOYOTA JIDOSHA KABUSHIKI KAISHA, Toyota-shi (JP)

(21) Appl. No.: 16/679,858

(22) Filed: Nov. 11, 2019

(30) Foreign Application Priority Data
Dec. 25, 2018 (JP) 2018-240879

(51) Int. Cl. G06N 5/02

(52) U.S. Cl. CPC G06N 5/02; H04W 4/029

(57) ABSTRACT

An information processing device includes an acquisition unit, a control unit and a giving unit. The acquisition unit can acquire vehicle information from an in-vehicle information processing device. The acquisition unit can acquire condition information from a terminal device. When acquiring the vehicle information, the control unit recognizes a weather when a vehicle detects clothes in the vehicle information. The control unit accumulates the clothes in a clothes database, in association with the weather and a position. When acquiring the condition information, the control unit recognizes a predicted weather at a designated time and a designated position. The control unit selects at least one kind of clothes, based on the clothes in the clothes database that are associated with the predicted weather and the position. The giving unit gives the at least one kind of clothes, to the terminal device that gives the condition information.

### INCORPORATION BY REFERENCE

The disclosure of Japanese Patent Application No. 2018-240879 filed on Dec. 25, 2018 including the specification, drawings and abstract is incorporated herein by reference in its entirety.

### BACKGROUND

### 1. Technical Field

The disclosure relates to an information processing device, an information processing system, a program, and an information processing method.

### 2. Description of Related Art

Generally, it is desired to select clothes that allow a person to feel comfortable in a visited place. The comfortableness of clothes can be perceived only when the person actually visits the place, and therefore, it is difficult to select clothes before the person visits the place. Therefore, it is known to propose suitable clothes in the visited place, based on an empirical rule or the like. For example, there has been proposed a system that displays a basic clothes preparation for a year in a travel destination city of an overseas travel and displays clothes of persons in the year in real time as advices determined from monthly average air temperature and monthly precipitation amount (see Japanese Patent Application Publication No. 2002-342655 (JP 2002-342655 A)).

### SUMMARY

However, in the system of JP 2002-342655 A, the proposition about clothes is based on the monthly average air temperature and the like for each city. Therefore, the credibility of the air temperature or the like at a particular position in a particular period is low, and it is difficult to improve the suitability of clothes to be proposed.

An object of the disclosure, which has been made in view of this circumstance, is to improve the suitability of clothes to be proposed.

An information processing device according to an embodiment of the disclosure includes: an acquisition unit that is able to acquire vehicle information from an in-vehicle information processing device and that is able to acquire condition information from a terminal device, the vehicle information including at least a position of a vehicle, the in-vehicle information processing device being mounted on the vehicle, the condition information including at least a designated time and a designated position; a control unit that, in a case of acquisition of the vehicle information including clothes of a person in a periphery of the vehicle, recognizes a weather when the vehicle detects the clothes in the vehicle information and accumulates the clothes in a clothes database in association with the weather and the position in the vehicle information, and that, in a case of acquisition of the condition information, recognizes a predicted weather at the designated time and the designated position in the condition information and selects at least one kind of clothes based on the clothes in the clothes database that are associated with a position and a weather respectively corresponding to the designated position and the predicted weather in the condition information; a storage unit that holds the clothes database; and a giving unit that gives the at least one kind of clothes to the terminal device that gives the condition information.

An information processing system according to an embodiment of the disclosure includes: an in-vehicle information processing device that gives vehicle information including at least a position of a vehicle; a terminal device that gives condition information including at least a designated time and a designated position; and an information processing device including a control unit that, in a case of acquisition of the vehicle information including clothes of a person in a periphery of the vehicle, recognizes a weather when the vehicle detects the clothes in the vehicle information and accumulates the clothes in a clothes database in association with the weather and the position in the vehicle information, and that, in a case of acquisition of the condition information, recognizes a predicted weather at the designated time and the designated position in the condition information and selects at least one kind of clothes based on the clothes in the clothes database that are associated with a position and a weather respectively corresponding to the designated position and the predicted weather in the condition information, a storage unit that holds the clothes database, and a giving unit that gives the at least one kind of clothes to the terminal device that gives the condition information.

A program according to an embodiment of the disclosure causes an information processing device to execute: a step of acquiring vehicle information from an in-vehicle information processing device, the vehicle information including at least a position of a vehicle, the in-vehicle information processing device being mounted on the vehicle; a step of, in a case of acquisition of the vehicle information including clothes of a person in a periphery of the vehicle, recognizing a weather when the vehicle detects the clothes in the vehicle information; a step of accumulating the clothes in a clothes database in association with the weather and the position in the vehicle information; a step of acquiring condition information from a terminal device, the condition information including at least a designated time and a designated position; a step of, in a case of acquisition of the condition information, recognizing a predicted weather at the designated time and the designated position in the condition information; a step of selecting at least one kind of clothes based on the clothes in the clothes database that are associated with a position and a weather respectively corresponding to the designated position and the predicted weather in the condition information; and a step of giving the at least one kind of clothes to the terminal device that gives the condition information.

An information processing method according to an embodiment of the disclosure includes: acquiring vehicle information from an in-vehicle information processing device, the vehicle information including at least a position of a vehicle, the in-vehicle information processing device being mounted on the vehicle; in a case of acquisition of the vehicle information including clothes of a person in a periphery of the vehicle, recognizing a weather when the vehicle detects the clothes in the vehicle information; accumulating the clothes in a clothes database in association with the weather and the position in the vehicle information; acquiring condition information from a terminal device, the condition information including at least a designated time and a designated position; in a case of acquisition of the condition information, recognizing a predicted weather at the designated time and the designated position in the condition information; selecting at least one kind of clothes based on the clothes in the clothes database that are associated with a position and a weather respectively corresponding to the designated position and the predicted weather in the condition information; and giving the at least one kind of clothes to the terminal device that gives the condition information.

With the information processing device, the information processing system, the program and the information processing method according to the embodiments of the disclosure, it is possible to improve the suitability of clothes to be proposed.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a configuration diagram showing a whole configuration of an information processing system including an information processing device according to an embodiment;

FIG. 2 is a functional block diagram showing a schematic configuration of a vehicle in FIG. 1;

FIG. 3 is a functional block diagram showing a schematic configuration of a terminal device in FIG. 1;

FIG. 4 is a functional block diagram showing a schematic configuration of an information processing device in FIG. 1;

FIG. 5 is a schematic diagram for simply describing a structure of a clothes database that is accumulated in a storage unit in FIG. 4;

FIG. 6 is a flowchart for describing a vehicle information giving process to be executed by a control unit that is of an in-vehicle information processing device in FIG. 2 and that does not perform extraction of an image of clothes;

FIG. 7 is a flowchart for describing a vehicle information giving process to be executed by a control unit that is of the in-vehicle information processing device in FIG. 2 and that performs the extraction of the image of the clothes;

FIG. 8 is a flowchart for describing a database accumulation process to be executed by a control unit in FIG. 4;

FIG. 9 is a flowchart for describing a condition information giving process to be executed by a control unit in FIG. 3; and

FIG. 10 is a flowchart for describing a clothes proposing process to be executed by the control unit in FIG. 4.

### DETAILED DESCRIPTION OF EMBODIMENTS

Hereinafter, embodiments will be described with reference to the drawings.

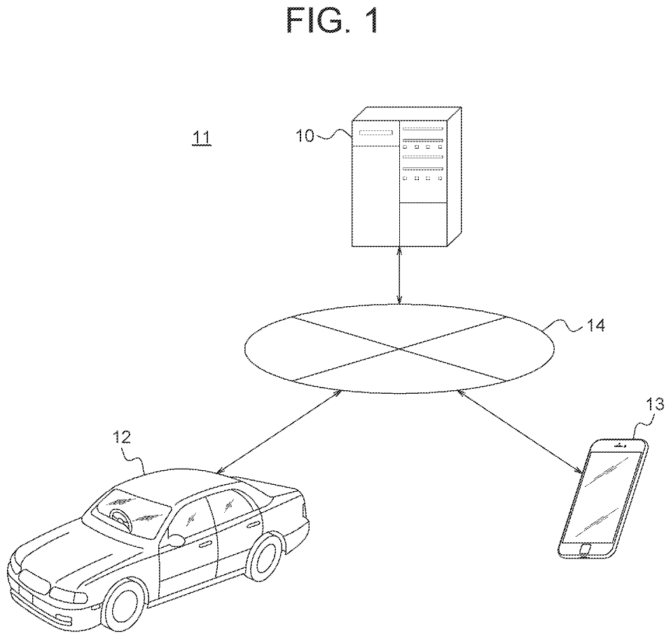

An outline of an information processing system 11 including an information processing device 10 according to an embodiment will be described with reference to FIG. 1. The information processing system 11 includes a vehicle 12, a terminal device 13 and an information processing device 10. For example, the vehicle 12 is an automobile. However, the vehicle 12 is not limited to automobiles, and may be an arbitrary vehicle. For example, the terminal device 13 is a general-purpose electronic device such as a smartphone or a personal computer (PC). However, the terminal device 13 is not limited to general-purpose electronic devices, and may be a dedicated electronic device for the information processing system 11. For simplification of description, in FIG. 1, one vehicle 12 and one terminal device 13 are illustrated. However, in the information processing system 11, the number of vehicles 12 and the number of terminal devices 13 each only need to be one or more. The information processing device 10 includes one server device or a plurality of server devices that can communicate with each other. Each of the vehicle 12, the terminal device 13 and the information processing device 10 is communicably connected with a network 14 including a mobile communication network and the internet, for example.

In the outline of the embodiment, the vehicle 12 gives vehicle information to the information processing device 10. The vehicle information includes the position of the vehicle 12, clothes of a person in the periphery, and the like. Based on the vehicle information acquired from the vehicle 12, the information processing device 10 recognizes a weather when the vehicle 12 detects the clothes of the person in the periphery. The information processing device 10 manages a clothes database, and accumulates the clothes of the persons in the periphery based on the vehicle information, in the clothes database, in association with the position of the vehicle 12 and the recognized weather. The terminal device 13 detects a user's input of a place that the user plans to visit and a period of time in which the user plans to stay. When the terminal device 13 detects the input, the terminal device 13 gives condition information including the period of time and the visited place as a designated time and a designated position respectively, to the information processing device 10. The information processing device 10 recognizes a predicted weather at the designated time and designated position in the condition information. The information processing device 10 selects at least one kind of clothes, based on clothes in the clothes database that are associated with a position and a weather respectively corresponding to the designated position in the condition information and the recognized predicted weather. The information processing device 10 gives the selected at least one kind of clothes, to the terminal device 13 that gives the condition information.

Thus, with the embodiment, the clothes of the person in the periphery of the vehicle 12 at a position and a period of time are detected from many vehicles 12 that travel in a wide region and in various periods of time. Furthermore, the clothes of the person in the periphery are accumulated in the clothes database. Using the clothes database, the clothes that the person in the periphery wore are searched for each position and each time, and the kind of actually worn clothes is selected based on the searched clothes. Accordingly, for the user, it is possible to propose clothes that are estimated to be comfortable in the period of time in which the user plans to stay in the visited place. Therefore, the suitability of clothes to be proposed is improved.

Next, each constituent of the information processing system 11 will be described in detail.

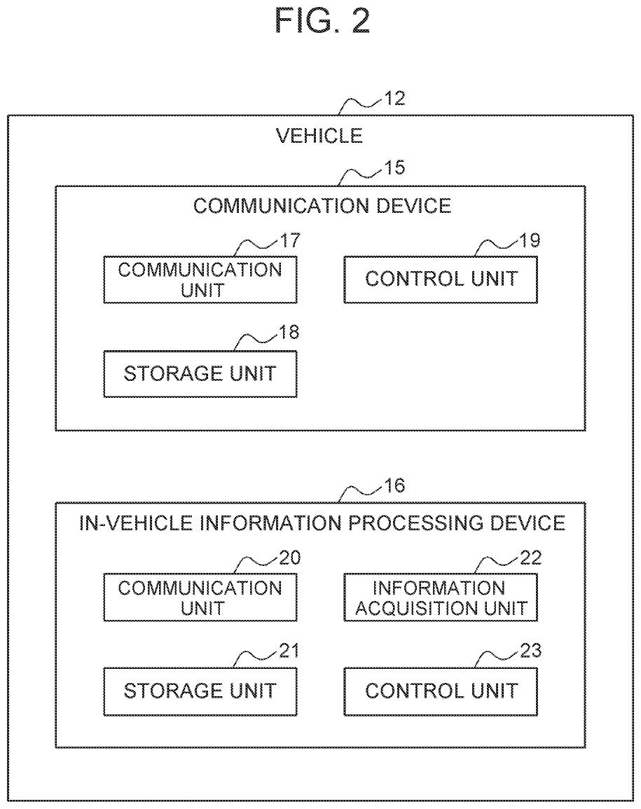

As shown in FIG. 2, on the vehicle 12, a communication device 15 and an in-vehicle information processing device 16 are mounted. The communication device 15 and the in-vehicle information processing device 16 are communicably connected with each other, through an in-vehicle network such as a controller area network (CAN) or a dedicated line, for example.

For example, the communication device 15 is an in-vehicle communicator such as a data communication module (DCM). Specifically, the communication device 15 includes a communication unit 17, a storage unit 18 and a control unit 19.

The communication unit 17 includes a communication module that performs communication through an in-vehicle network or a dedicated line. The communication unit 17 includes a communication module that is connected to the network 14. For example, the communication unit 17 may include a communication module for a mobile communication standard such as 4th generation (4G) and 5th generation (5G). In the embodiment, the vehicle 12 is connected to the network 14 through the communication unit 17.

The storage unit 18 includes one or more memories. In the embodiment, the “memory” is a semiconductor memory, a magnetic memory or an optical memory, for example, but is not limited to them. For example, each memory included in the storage unit 18 may function as a main storage device, an auxiliary storage device or a cache memory. The storage unit 18 holds arbitrary information that is used for operation of the communication device 15. For example, the storage unit 18 may hold a system program, an application program and the like. Identification information about the vehicle 12 is information that allows the vehicle 12 to be uniquely identified in the information processing system 11. The information held in the storage unit 18 may be updatable, for example, to information that is acquired from the network 14 through the communication unit 17.

The control unit 19 includes one or more processors. In the embodiment, the “processor” is a general-purpose processor or a dedicated processor for a particular process, but is not limited to them. The control unit 19 controls the whole operation of the communication device 15. In the embodiment, the vehicle 12 communicates with the information processing device 10, through the communication device 15 that is controlled by the control unit 19. By communicating with the information processing device 10, the vehicle 12 acquires or gives information or the like.

For example, the in-vehicle information processing device 16 is a navigation device that manages a variety of information in the vehicle 12. For example, the in-vehicle information processing device 16 collects later-described detection information in the vehicle 12. The in-vehicle information processing device 16 gives the collected detection information to the information processing device 10 through the communication device 15, as the vehicle information, with no change or after processing. The in-vehicle information processing device 16 includes a communication unit 20, a storage unit 21, an information acquisition unit 22 and a control unit 23.

The communication unit 20 is a communication module that performs communication through an in-vehicle network or a dedicated line.

The storage unit 21 includes one or more memories. For example, each memory included in the storage unit 21 may function as a main storage device, an auxiliary storage device or a cache memory. The storage unit 21 holds arbitrary information that is used for operation of the in-vehicle information processing device 16. For example, the storage unit 21 may hold a system program, an application program and the like. The information held in the storage unit 21 may be updatable, for example, to information that is acquired from the network 14 through the communication device 15.

The information acquisition unit 22 acquires the detection information that is detected by various sensors mounted on the vehicle 12, directly or through an electronic control unit (ECU). For example, the detection information includes the position of the vehicle 12, an image of the periphery of the vehicle 12, the air temperature outside the vehicle 12, the humidity outside the vehicle 12, the wind speed outside the vehicle 12, the precipitation amount outside the vehicle 12, and time.

For example, the position of the vehicle 12 is the position of the vehicle 12 on a map, which is a position detected by a global positioning system (GPS) receiver or the like. For example, the image of the periphery of the vehicle 12 shows an image obtained by picking up at least one of a forward view, a rearward view and a lateral view from the vehicle 12. The forward view, the rearward view and the lateral view are detected by an in-vehicle camera. The periphery image can include a picture of clothes that are worn by the person in the periphery of the vehicle 12. In other words, the periphery image can include the clothes of the person in the periphery, as information. The clothes may include an accessory in addition to a garment. The clothes are worn for partially covering the body of the person. The accessory is added for causing the body of the person to appear beautifully or excellently. For example, the air temperature outside the vehicle 12 shows an air temperature outside the vehicle 12 that is detected by a temperature sensor. For example, the humidity outside the vehicle 12 shows a humidity outside the vehicle 12 that is detected by a humidity sensor. For example, the wind speed outside the vehicle 12 shows a wind speed outside the vehicle 12 that is detected by a wind speed sensor. For example, the precipitation amount outside the vehicle 12 shows a precipitation amount in the periphery of the vehicle 12 that is detected by a rainfall amount sensor. For example, the time shows a cyclic hour that is given from a timer.

The control unit 23 includes one or more processors. The control unit 23 controls the whole operation of the in-vehicle information processing device 16.

For example, the control unit 23 stores a plurality of pieces of detection information acquired in the information acquisition unit 22 at the same time, in the storage unit 21, in association with each other. Here, the same time is a period after a time acquisition at a cyclic hour to be cyclically given by the timer and before a time acquisition at the next hour. When the control unit 23 acquires the image of the periphery of the vehicle 12, the control unit 23 may detect the clothes of the person in the periphery of the own vehicle 12, may generate the clothes as information, and may add the clothes to the detection information, as described later. The clothes as information are characteristics allowing identification of the clothes, as exemplified by an image of clothes themselves. Furthermore, when the control unit 23 acquires the periphery image, together with the clothes of the person in the periphery, the control unit 23 may estimate at least one of the sex and generation of the person in the periphery, may generate the attribute as information, and may add the attribute to the detection information.

The control unit 23 gives the detection information temporarily stored in the storage unit 21, to the information processing device 10, as the vehicle information relevant to the own vehicle 12. The control unit 23 gives the vehicle information including at least the position of the vehicle 12, to the information processing device 10. The control unit 23 may give the vehicle information to the information processing device 10, for example, cyclically, periodically, or at an arbitrary timing such as the time of the acquisition of the periphery image.

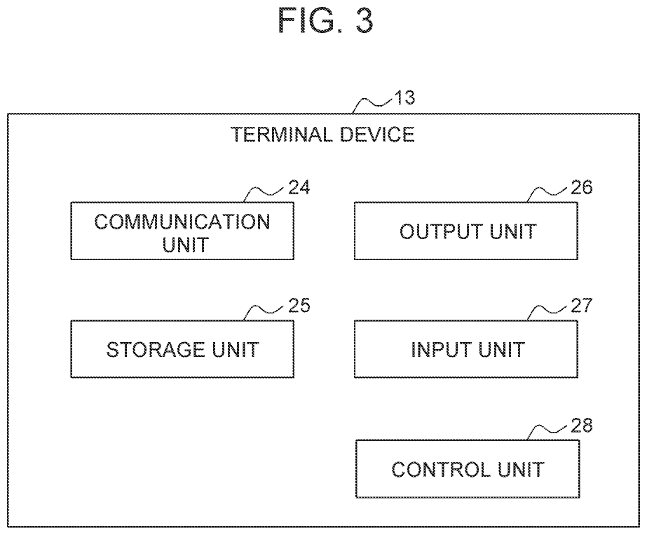

As shown in FIG. 3, the terminal device 13 includes a communication unit 24, a storage unit 25, an output unit 26, an input unit 27 and a control unit 28.

The communication unit 24 includes a communication module that is connected to the network 14. For example, the communication unit 24 may include a communication module for a mobile communication standard such as 4G and 5G. In the embodiment, the terminal device 13 is connected to the network 14 through the communication unit 24.

The storage unit 25 includes one or more memories. For example, each memory included in the storage unit 25 may function as a main storage device, an auxiliary storage device or a cache memory. The storage unit 25 holds arbitrary information that is used for operation of the terminal device 13. For example, the storage unit 25 may store a system program, an application program, the sex or generation of the user, a list of clothes possessed by the user, the identification information about the terminal device 13, and the like. The information held in the storage unit 25 may be updatable, for example, to information that is acquired from the network 14 through the communication unit 24.

The output unit 26 includes one or more output interfaces each of which outputs information to give a notice to the user. The output interface included in the output unit 26 is a display that outputs the information by video, or a speaker that outputs the information by voice, for example, but is not limited to them.

The input unit 27 includes one or more input interfaces each of which detects a user's input. The input interface included in the input unit 27 is a physical key, a capacitive key, a touch screen that is provided integrally with the display of the output unit 26, or a microphone that accepts a voice input, for example, but is not limited to them.

The control unit 28 includes one or more processors. The control unit 28 controls the whole operation of the terminal device 13.

When the input unit 27 detects an input for requesting a clothes proposition for the visited place from the user, the control unit 28 causes the output unit 26 to output an inquiry about the position of the visited place and the period of time in which the user plans to stay. When the input unit 27 detects an input of the position of the visited place and the period of time in which the user plans to stay, the control unit 28 gives the condition information including at least the position and the period of time as the designated position and the designated time respectively, to the information processing device 10, through the communication unit 24. The period of time in which the user plans to stay may include a date and hour when the user plans to stay. Accordingly, the designated time may include a designated date and a designated hour.

The control unit 28 may give the condition information including attributes of the user, as exemplified by the sex and the age, to the information processing device 10. Furthermore, the control unit 28 may give the condition information including the list of the clothes possessed by the user, to the information processing device 10.

Furthermore, the control unit 28 may give the condition information including the predicted weather that is a result of prediction of a future weather at the designated time and the designated position, to the information processing device 10.

The terminal device 13 can acquire the predicted weather from a weather information providing device through the communication unit 24 and the network 14. For example, the weather information providing device is a device that is managed by an organization for accumulating actual weather at a plurality of positions and creating the predicted weather that is a result of prediction of a future weather in each place, for example, by Japan Meteorological Agency. The weather information providing device provides actual weather and predicted weather at various times in various places. For example, each of the actual weather and predicted weather to be provided by the weather information providing device may include the air temperature, the wind speed, the humidity and the rainfall condition.

When the control unit 28 acquires at least one kind of clothes from the information processing device 10 after the condition information is given, the control unit 28 causes the output unit 26 to output the at least one kind, as an optimal kind of clothes to the condition information. Alternatively, when the control unit 28 acquires at least one kind of clothes from the information processing device 10, the control unit 28 may cause the output unit 26 to output clothes that are in the list of the clothes and that are similar to the acquired kind of clothes. The clothes similar to the acquired kind of clothes is a combination of clothes allowing a cold protection property comparable to the cold protection property of the acquired kind of clothes.

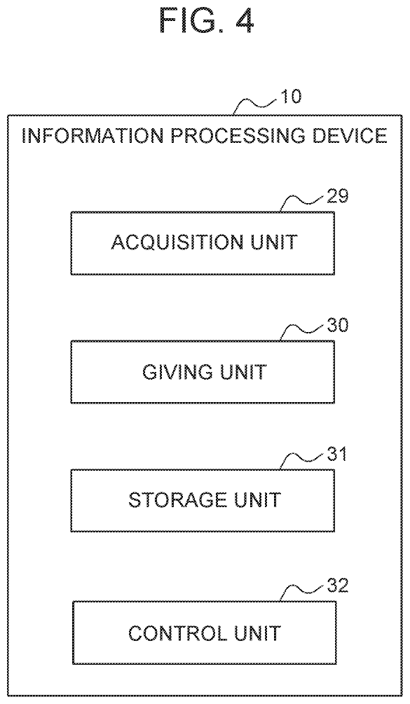

As shown in FIG. 4, the information processing device 10 includes an acquisition unit 29, a giving unit 30, a storage unit 31, and a control unit 32.

For example, the acquisition unit 29 includes a communication module that is connected to the network 14. For example, the acquisition unit 29 may include a communication module for a wired local area network (LAN) standard. In the embodiment, the information processing device 10 is connected to the network 14 through the acquisition unit 29. The acquisition unit 29 can acquire the vehicle information and the condition information from the vehicle 12 and the terminal device 13, respectively.

For example, the giving unit 30 includes a communication module that is connected to the network 14. For example, the giving unit 30 may include a communication module for a wired LAN standard. For example, the giving unit 30 gives a variety of information including at least one kind of clothes, and commands, to the vehicle 12, as described later. The giving unit 30 may be provided integrally with the acquisition unit 29.

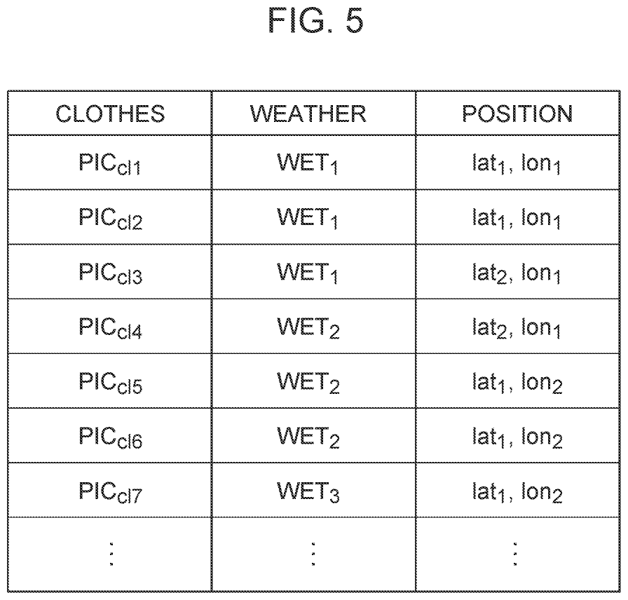

The storage unit 31 includes one or more memories. For example, each memory included in the storage unit 31 may function as a main storage device, an auxiliary storage device or a cache memory. The storage unit 31 holds arbitrary information that is used for operation of the information processing device 10. For example, the storage unit 31 may hold a system program, an application program and the clothes database. As shown in FIG. 5, the clothes database is an information group in which the clothes detected by the vehicle 12 are associated with the weather and the position of the vehicle 12 when the clothes are detected, as described later. Furthermore, in the clothes database, the clothes detected by the vehicle 12 may be associated with attributes of the person wearing the clothes, as exemplified by the sex and the generation. The information held in the storage unit 31 may be updatable, for example, to information that is acquired from the network 14 through the acquisition unit 29.

The control unit 32 includes one or more processors. The control unit 32 controls the whole operation of the information processing device 10.

When the control unit 32 acquires the vehicle information from the in-vehicle information processing device 16, the control unit 32 determines whether the vehicle information includes the periphery image or whether the vehicle information includes the clothes of the person in the periphery. In the case where the vehicle information includes the periphery image, the control unit 32 analyzes the image, and extracts the picture of the clothes of the person in the periphery of the vehicle 12 from the image. In the case where the control unit 32 cannot extract the picture of the clothes, the control unit 32 does not update the clothes database. Further, in the case where the control unit 32 detects pictures of the same clothes in the vehicle information acquired at a plurality of times in a short period from the same vehicle 12, the control unit 32 may regard the clothes as identical clothes, and may skip the update of the clothes database. In the case where the control unit 32 can extract the picture of the clothes and where the vehicle information includes the clothes of the person in the periphery as described above, the control unit 32 performs accumulation in the clothes database as described later.

In the update of the clothes database, the control unit 32 recognizes the weather when the clothes in the vehicle information are detected, in other words, the weather when the periphery image is detected. In the case where the vehicle information includes the weather, the control unit 32 recognizes the weather when the periphery image is detected, by acquiring the weather in the vehicle information. For example, the weather includes at least one of the air temperature, the humidity, the wind speed and the precipitation amount. Furthermore, the weather may include weather kind such as fair weather, cloudy weather, rainy weather and snowy weather, snowfall amount or solar radiation amount. In the case where the vehicle information does not include at least some of the above items relevant to the weather, the control unit 32 may recognize the actual weather at the position of the vehicle 12 when the periphery image is detected, based on the time and the position in the vehicle information, by acquiring the actual weather from the weather information providing device through the acquisition unit 29 and the network 14.

In the update of the clothes database, the control unit 32 may estimate the sex and generation of the person that wore the clothes, while recognizing the extracted clothes or the clothes in the vehicle information.

After the control unit 32 detects the weather when the clothes are detected, the control unit 32 accumulates the extracted clothes or the clothes in the vehicle information, in the clothes database, in association with the recognized weather and the position of the vehicle 12 in the vehicle information. Furthermore, the control unit 32 may accumulate the extracted clothes or the clothes in the vehicle information, in the clothes database, in association with the sex and generation of the person that wore the clothes.

When the control unit 32 acquires the condition information from terminal device 13, the control unit 32 recognizes the predicted weather at the designated time and the designated position in the condition information. For example, the control unit 32 recognizes the predicted weather, by acquiring the predicted weather from the weather information providing device through the acquisition unit 29 and the network 14. In the case where the condition information includes the predicted weather, the control unit 32 may recognize the predicted weather by acquiring the condition information.

After the recognition of the predicted weather, the control unit 32 reads clothes associated with a position and a weather respectively corresponding to the designated position in the vehicle information and the predicted weather, from the clothes database stored in the storage unit 31. In the case where the condition information includes the attributes, the control unit 32 may read clothes that is of the clothes associated with the position and the weather and that are further associated with the sex and the generation in the attributes, from the clothes database. The control unit 32 selects at least one kind of clothes, based on the read clothes.

The position corresponding to the designated position may include an actual position within a 500 meter radius. The weather corresponding to the predicted weather is not limited to the weather that completely coincides with the predicted weather, and may have a margin from the predicted weather. For example, the air temperature corresponding to the predicted air temperature may include an actual air temperature range of ±2° C. Further, for example, the humidity corresponding to the predicted humidity may include an actual humidity range of ±5%. Further, for example, the wind speed corresponding to the predicted wind speed may include an actual wind speed range of ±3 m/s. Further, for example, the precipitation amount corresponding to the predicted precipitation amount may include an actual precipitation amount range of ±1 mm.

The control unit 32 analyzes the kind of the clothes read from the clothes database. As the analysis of the kind of the clothes, for example, the control unit 32 analyzes the kind and quantity of clothes for cold weather or warm weather. For example, for the upper half of the body, the control unit 32 analyzes whether the sleeves are long or short, whether the person wears only a shirt, whether the person wears a sweater or the like on a shirt, whether the person wears an outer, the kind of an outer, and the like. For example, for the lower half of the body, the control unit 32 analyzes whether the person wears short pants or long pants, whether socks are long or short, whether the person wears stockings. Further, the analysis of the kind of the clothes may include the analysis of the kind of shoes such as boots in a wet zone as the visited place. In the analysis, the control unit 32 may classify clothes with the same degree of cold protection property, into an identical group.

The control unit 32 determines a standard kind from the read kinds of clothes, based on the analysis result. The standard kind is a kind having the greatest frequency or a frequency of the top 60% of all samples. The control unit 32 selects at least one kind of clothes that is determined to be standard.

In the case where the condition information includes the list of the clothes possessed by the user, the control unit 32 may select clothes similar to the selected kind of clothes in the list of the clothes. The clothes similar to the selected kind of clothes are a combination of clothes allowing a cold protection property comparable to the cold protection property of the selected kind of clothes.

The control unit 32 may search the selected at least one kind of clothes, on a search site in the internet, and may select clothes that are estimated to prevail, from the kind of clothes.

After the control unit 32 selects at least one kind of clothes, the control unit 32 gives the kind to the terminal device 13 that gives the condition information. The control unit 32 may give the kind to the terminal device 13, as text data. In the case where the control unit 32 selects clothes from the clothes list, the control unit 32 may give the clothes selected from the clothes list, in addition to or instead of the at least one kind of clothes. In the case where the control unit 32 selects clothes that are estimated to prevail, the control unit 32 may give the estimated clothes, in addition to or instead of the at least one kind of clothes.

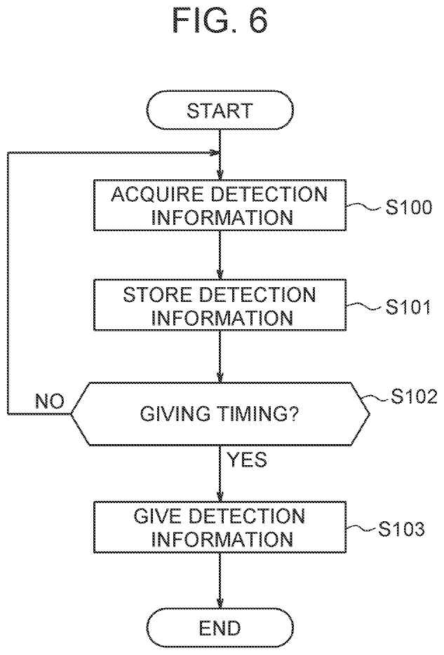

Next, a vehicle information giving process to be executed by the control unit 23 that is of the in-vehicle information processing device 16 in the embodiment and that does not perform the extraction of the image of clothes will be described with use of a flowchart of FIG. 6. For example, the vehicle information giving process starts at the same time as the giving of the vehicle information to the information processing device 10.

In step S100, the control unit 23 acquires the detection information. After the acquisition of the detection information, the process proceeds to step S101.

In step S101, the control unit 23 stores the detection information acquired in step S100, in the storage unit 21, in association with the time of the acquisition. After the storing, the process proceeds to step S102.

In step S102, the control unit 23 determines whether the current timing is a giving timing. In the case where the current timing is not a giving timing, the process returns to step S100. In the case where the current timing is a giving timing, the process proceeds to step S103.

In step S103, the control unit 23 gives a plurality of kinds of detection information stored for each time in step S101, as the vehicle information, to the information processing device 10 through the communication unit 20. After the giving, the vehicle information giving process ends.

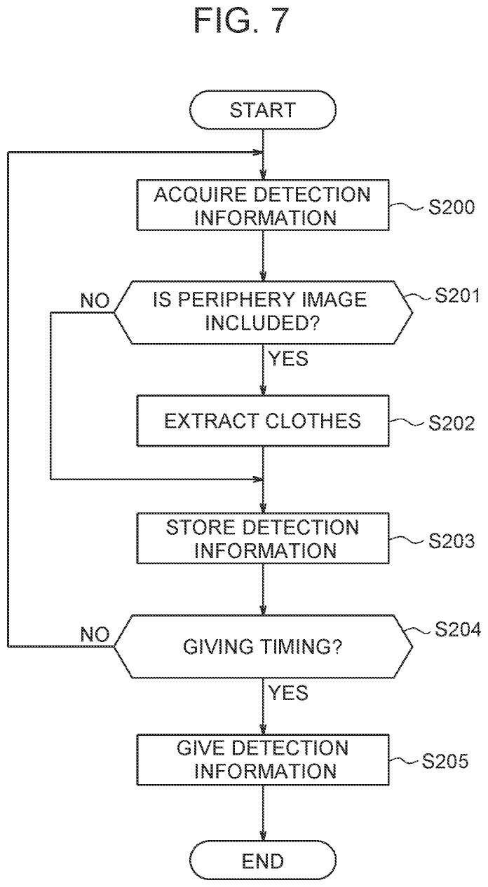

Next, a vehicle information giving process to be executed by the control unit 23 that is of the in-vehicle information processing device 16 in the embodiment and that performs the extraction of the image of clothes will be described with use of a flowchart of FIG. 7. For example, the vehicle information giving process starts at the same time as the giving of the vehicle information to the information processing device 10.

In step S200, the control unit 23 acquires the detection information. After the acquisition of the detection information, the process proceeds to step S201.

In step S201, the control unit 23 determines whether the periphery image is included in the vehicle information acquired in step S200. In the case where the periphery image is included, the process proceeds to step S202. In the case where the periphery image is not included, the process proceeds to step S203.

In step S202, the control unit 23 extracts the picture of clothes from the periphery image in the vehicle information acquired in step S200. Further, the control unit 23 estimates the sex and generation of the person that wears the clothes in the extracted picture. After the extraction, the process proceeds to step S202.

In step S203, the control unit 23 stores the detection information acquired in step S200, in the storage unit 21, in association with the time of the acquisition. On this occasion, in the case where the control unit 23 can extract the picture of the clothes in step S202, the control unit 23 stores the picture of the clothes, and in the case where the control unit 23 can estimate the sex and generation of the person that wears the clothes in step S202, the control unit 23 stores the attributes. After the storing, the process proceeds to step S204.

In step S204 and step S205, the control unit 23 executes the same operation as step S102 and step S103 of the vehicle information giving process to be executed by the control unit 23 that does not performs the extraction of the image of the clothes. After the giving of the vehicle information in step S205, the vehicle information giving process ends.

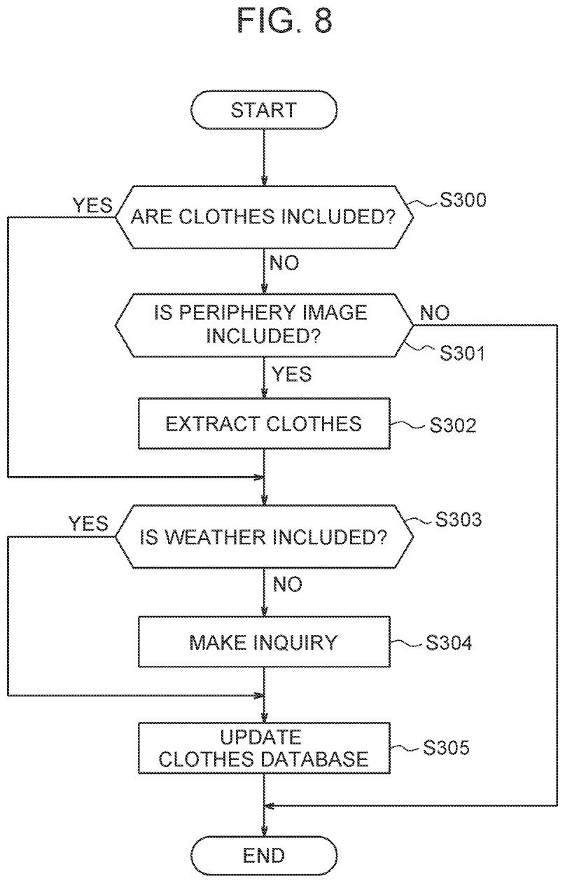

Next, a database accumulation process to be executed by the control unit 32 of the information processing device 10 in the embodiment will be described with use of a flowchart of FIG. 8. For example, the database accumulation process starts whenever the vehicle information is acquired.

In step S300, the control unit 32 determines whether the clothes of the person in the periphery are included in the acquired vehicle information. In the case where the clothes of the person in the periphery are included, the process proceeds to step S303. In the case where the clothes of the person in the periphery are not included, the process proceeds to step S301.

In step S301, the control unit 32 determines whether the periphery image is included in the acquired vehicle information. In the case where the periphery image is not included, the database accumulation process ends. In the case where the periphery image is included, the process proceeds to step S302.

In step S302, the control unit 32 extracts the picture of the clothes, from the periphery image in the acquired vehicle information. Further, the control unit 32 estimates the sex and generation of the person that wears the clothes for which the picture is extracted. After the extraction, the process proceeds to step S303.

In step S303, the control unit 32 determines whether the weather is included in the acquired vehicle information. In the case where the weather is included, the process proceeds to step S305. In the case where the weather is not included, the process proceeds to step S304.

In step S304, the control unit 32 reads the time and the position in the acquired vehicle information, and acquires the actual weather at the time and the position by making an inquiry to the weather information providing device. After the acquisition, the process proceeds to step S305.

In step S305, the control unit 32 updates the clothes database, by storing the clothes of the person in the periphery recognized in step S300 or the clothes extracted in step S302, in the storage unit 31, in association with the weather recognized in step S303 or the weather acquired in step S304 and the position in the acquired vehicle information. After the update, the database accumulation process ends.

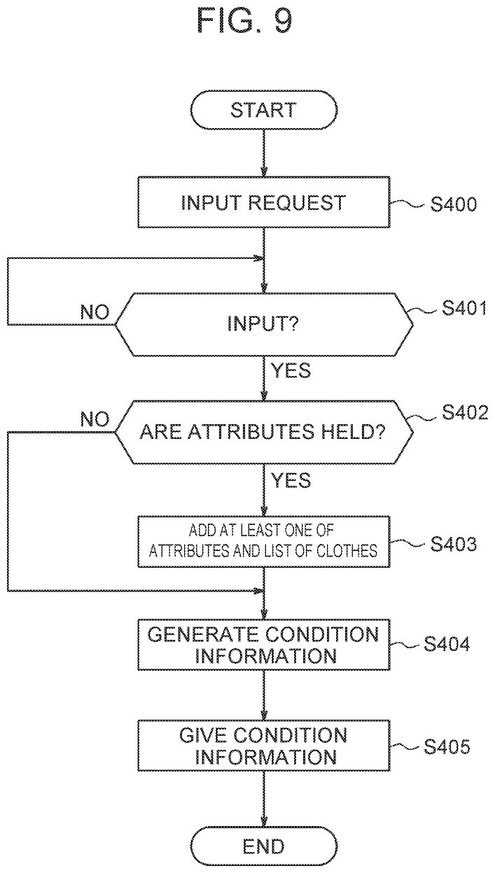

Next, a condition information giving process to be executed by the control unit 28 of the terminal device 13 in the embodiment will be described with use of a flowchart of FIG. 9. For example, the condition information giving process starts when the input unit 27 detects the user's input for requesting the clothes proposition for the visited place.

In step S400, the control unit 28 causes the output unit 26 to output the inquiry about the position of the visited place and the period of time in which the user plans to stay. After the output, the process proceeds to step S401.

In step S401, the control unit 28 determines whether the input unit 27 has detected the input of the position of the visited place and the period of time in which the user plans to stay. In the case where the input unit 27 has not detected the input, the process repeats step S401. In the case where the input unit 27 has detected the input, the process proceeds to step S402.

In step S402, the control unit 28 determines whether the storage unit 25 holds the attributes, that is, the sex and generation of the user. Further, the control unit 28 determines whether the storage unit 25 holds the list of the clothes of the user. Further, the control unit 28 determines whether the storage unit 25 holds the predicted weather in the period of time in which the user plans to stay. The input of the period of time in which the user plans to stay is checked in step S401. In the case where the storage unit 25 holds neither the list of the clothes of the user nor the predicted weather in the period of time in which the user plans to stay, the process proceeds to step S404. In the case where the storage unit 25 holds either the list of the clothes of the user or the predicted weather in the period of time in which the user plans to stay, the process proceeds to step S403.

In step S403, the control unit 28 decides addition of at least one of the held attributes and the held list of the clothes that are checked in step S402, to the condition information. After the decision, the process proceeds to step S404.

In step S404, the control unit 28 generates the condition information including the position of the visited place and the period of time in which the user plans to stay, for which the input is detected in step S401, as the designated position and the designated time respectively, and including items to be added when the addition to the condition information is decided in step S403. After the generation, the process proceeds to step S405.

In step S405, the control unit 28 gives the condition information generated in step S404, to the information processing device 10, through the communication unit 24.

After the giving, the condition information giving process ends.

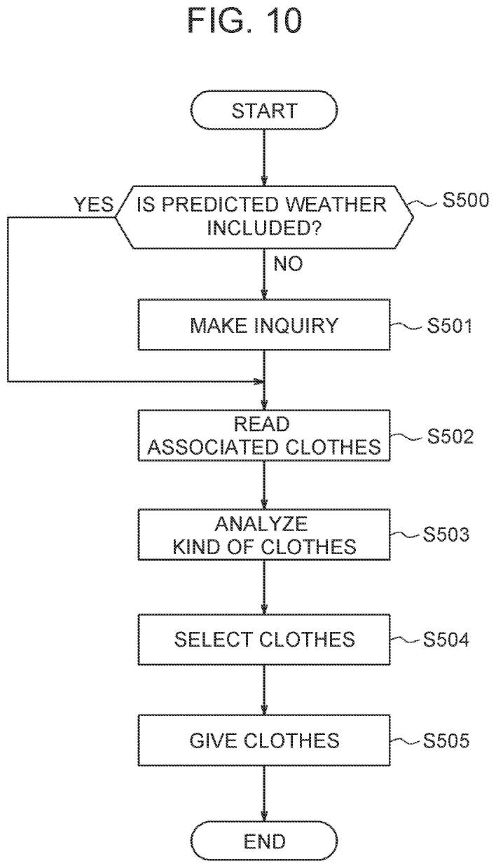

Next, a clothes proposing process to be executed by the control unit 32 of the information processing device 10 in the embodiment will be described with use of a flowchart of FIG. 10. For example, the clothes proposing process starts when the condition information is acquired.

In step S500, the control unit 32 determines whether the predicted weather is included in the acquired condition information. In the case where the predicted weather is included, the process proceeds to step S502. In the case where the predicted weather is not included, the process proceeds to step S501.

In step S501, the control unit 32 reads the designated position and the designated time in the acquired condition information, and acquires the predicted weather at the time and the position by making an inquiry to the weather information providing device. After the acquisition, the process proceeds to step S502.

In step S502, the control unit 32 reads the designated position included in the condition information, and the predicted weather checked in step S500 or the predicted weather acquired in step S501, from the clothes database in the storage unit 31. On this occasion, in the case where the attributes are included in the condition information, the control unit 32 reads clothes associated with the attributes, from the clothes database. After the reading, the process proceeds to step S503.

In step S503, the control unit 32 analyzes the kind of the clothes read in step S502. After the analysis, the process proceeds to step S504.

In step S504, the control unit 32 selects at least one kind of standard clothes, based on the analysis result in step S503. After the selection, the process proceeds to step S505.

In step S505, the control unit 32 gives the at least one kind of clothes selected in step S504, to the terminal device 13 that gives the condition information. After the giving, the clothes proposing process ends.

When the thus configured information processing device 10 in the embodiment acquires the vehicle information including the position of the vehicle 12 and the clothes of the person in the periphery, the information processing device 10 recognizes the weather when the clothes of the person in the periphery are detected, and accumulates the clothes of the person in the periphery, in the clothes database, in association with the recognized weather and the position of the vehicle 12. With this configuration, the information processing device 10 can accumulate data of the clothes of the person at an arbitrary position and an arbitrary weather. Furthermore, when the information processing device 10 acquires the condition information including at least the designated time and the designated position, the information processing device 10 recognizes the predicted weather at the designated time and the designated position, reads the clothes associated with the position and the weather respectively corresponding to the designated position and the predicted weather, from the clothes database, and based on the read clothes, gives at least one kind of clothes to the terminal device 13 that gives the condition information. With this configuration, the information processing device 10 can inform the user of the terminal device 13, about the kind of clothes that were actually worn in the visited place in a weather equivalent to the predicted weather in the visited place in the period of time in which the user plans to stay. Accordingly, the information processing device 10 can propose clothes corresponding to a weather in a narrow region on a particular date, and therefore, can improve the suitability of clothes to be proposed.

In the information processing device 10 according to the embodiment, each of the weather when the vehicle 12 detects the clothes and the predicted weather includes at least one of the air temperature, the wind speed and the humidity. The wind speed and the humidity influence feeling temperature and diffusivity of body temperature, respectively. Therefore, generally, the comfortableness of clothes is influenced also by factors other than the air temperature. For such a phenomenon, with the above configuration, the information processing device 10 can further improve the suitability of the proposition of clothes.

In the information processing device 10 according to the embodiment, the designated time includes the designated date and the designated hour. With this configuration, the information processing device 10 can further improve the proposition of comfortable clothes, to deal with the change in weather during the day.

The information processing device 10 in the embodiment recognizes the weather, by acquiring the weather when the vehicle 12 detects the clothes of the person in the periphery that is included in the vehicle information. With this configuration, the information processing device 10 can accumulate actual local weather in the clothes database, in association with the clothes. Accordingly, the information processing device 10 can further improve the proposition of comfortable clothes.

The information processing device 10 in the embodiment recognizes the weather, by acquiring the actual weather at the time and place when the vehicle 12 detects the clothes of the person in the periphery that is included in the vehicle information, from the weather information providing device. With this configuration, for the accumulation in the clothes database, the information processing device 10 can use even the vehicle information acquired from the vehicle 12 that is not equipped with some of the sensors for detecting the weather.

The disclosure has been described based on the drawings and the embodiment. Note that a person skilled in the art can easily make various modifications and alterations based on the disclosure. Accordingly, it should be understood that the modifications and the alterations are included in the scope of the disclosure. For example, functions and the like that are included in the units and the steps can be rearranged without a logical inconsistency. A plurality of units or steps can be integrated to one unit or step, or can be divided.

For example, in the above-described embodiment, an example in which the communication device 15 is an in-vehicle communicator and the in-vehicle information processing device 16 is a navigation device mounted on the vehicle 12 has been described. However, some or all of the processing operations that are executed by the communication device 15 and the in-vehicle information processing device 16 may be executed, for example, by an arbitrary electronic device such as a smartphone or a computer.

For example, some of the processing operations that are executed by the in-vehicle information processing device 16 in the above-described embodiment may be executed by the information processing device 10. Some of the processing operations that are executed by the information processing device 10 may be executed by the in-vehicle information processing device 16 or the terminal device 13.

For example, a general-purpose electronic device such as a smartphone or a computer may function as the communication device 15, the in-vehicle information processing device 16 or the information processing device 10 according to the above-described embodiment. Specifically, a program specifying processing contents for realizing functions of the communication device 15 and the like according to the embodiment is stored in a memory of the electronic device, and the program is read and executed by a processor of the electronic device. Therefore, the disclosure according to the embodiment can be realized also as a program that can be executed by a processor.

What is claimed is:

1. An information processing device comprising:
an acquisition unit that is able to acquire vehicle information from an in-vehicle information processing device and that is able to acquire condition information from a terminal device, the vehicle information including at least a position of a vehicle, the in-vehicle information processing device being mounted on the vehicle, the condition information including at least a designated time and a designated position;
a control unit that, in a case of acquisition of the vehicle information including clothes of a person in a periphery of the vehicle, recognizes a weather when the vehicle detects the clothes in the vehicle information and accumulates the clothes in a clothes database in association with the weather and the position in the vehicle information, and that, in a case of acquisition of the condition information, recognizes a predicted weather at the designated time and the designated position in the condition information and selects at least one kind of clothes based on the clothes in the clothes database that are associated with a position and a weather respectively corresponding to the designated position and the predicted weather in the condition information;
a storage unit that holds the clothes database; and
a giving unit that gives the at least one kind of clothes to the terminal device that gives the condition information.

2. The information processing device according to claim 1, wherein each of the weather when the vehicle detects the clothes in the vehicle information and the predicted weather includes at least one of an air temperature, a wind speed and a humidity.

3. The information processing device according to claim 1, wherein the designated time includes a designated date and a designated hour.

4. The information processing device according to claim 1, wherein:
the vehicle information includes the weather when the vehicle detects the clothes of the person in the periphery; and
in the case of the acquisition of the vehicle information, the control unit recognizes the weather when the vehicle that gives the vehicle information detects the clothes in the vehicle information, based on the weather in the vehicle information.

5. The information processing device according to claim 1, wherein:
the acquisition unit is able to acquire actual weather at a plurality of positions, from a weather information providing device;
the vehicle information includes a time when the vehicle detects the clothes of the person in the periphery; and
in the case of the acquisition of the vehicle information, the control unit recognizes the weather when the vehicle that gives the vehicle information detects the clothes in the vehicle information, by acquiring an actual weather at the time and the position in the vehicle information from the weather information providing device through the acquisition unit.

6. An information processing system comprising:
an in-vehicle information processing device that gives vehicle information including at least a position of a vehicle;
a terminal device that gives condition information including at least a designated time and a designated position; and
an information processing device including
a control unit that, in a case of acquisition of the vehicle information including clothes of a person in a periphery of the vehicle, recognizes a weather when the vehicle detects the clothes in the vehicle information and accumulates the clothes in a clothes database in association with the weather and the position in the vehicle information, and that, in a case of acquisition of the condition information, recognizes a predicted weather at the designated time and the designated position in the condition information and selects at least one kind of clothes based on the clothes in the clothes database that are associated with a position and a weather respectively corresponding to the designated position and the predicted weather in the condition information,
a storage unit that holds the clothes database, and
a giving unit that gives the at least one kind of clothes to the terminal device that gives the condition information.

7. A program that causes an information processing device to execute:
a step of acquiring vehicle information from an in-vehicle information processing device, the vehicle information including at least a position of a vehicle, the in-vehicle information processing device being mounted on the vehicle;
a step of, in a case of acquisition of the vehicle information including clothes of a person in a periphery of the vehicle, recognizing a weather when the vehicle detects the clothes in the vehicle information;
a step of accumulating the clothes in a clothes database in association with the weather and the position in the vehicle information;
a step of acquiring condition information from a terminal device, the condition information including at least a designated time and a designated position;
a step of, in a case of acquisition of the condition information, recognizing a predicted weather at the designated time and the designated position in the condition information;
a step of selecting at least one kind of clothes based on the clothes in the clothes database that are associated with a position and a weather respectively corresponding to the designated position and the predicted weather in the condition information; and
a step of giving the at least one kind of clothes to the terminal device that gives the condition information.

8. An information processing method comprising:
acquiring vehicle information from an in-vehicle information processing device, the vehicle information including at least a position of a vehicle, the in-vehicle information processing device being mounted on the vehicle;
in a case of acquisition of the vehicle information including clothes of a person in a periphery of the vehicle, recognizing a weather when the vehicle detects the clothes in the vehicle information;
accumulating the clothes in a clothes database in association with the weather and the position in the vehicle information;
acquiring condition information from a terminal device, the condition information including at least a designated time and a designated position;
in a case of acquisition of the condition information, recognizing a predicted weather at the designated time and the designated position in the condition information;
selecting at least one kind of clothes based on the clothes in the clothes database that are associated with a position and a weather respectively corresponding to the designated position and the predicted weather in the condition information; and
giving the at least one kind of clothes to the terminal device that gives the condition information.
